(19) United States
(12) Patent Application Publication
(10) Pub. No.: US 2018/0060986 A1
(43) Pub. Date: Mar. 1, 2018

(54) INFORMATION PROCESSING DEVICE, ROAD STRUCTURE MANAGEMENT SYSTEM, AND ROAD STRUCTURE MANAGEMENT METHOD

(71) Applicant: Kabushiki Kaisha Toshiba, Minato-ku, Tokyo (JP)

(72) Inventors: Yoshihiko SUZUKI, Suginami Tokyo (JP); Toshio SATO, Yokohama Kanagawa (JP); Hideki UENO, Urayasu Chiba (JP); Yusuke TAKAHASHI, Tama Tokyo (JP); Kentaro YOKOI, Tachikawa Tokyo (JP); Kenji KIMIYAMA, Kawasaki Kanagawa (JP); Yasuhiro AOKI, Kawasaki Kanagawa (US)

(21) Appl. No.: 15/551,447

(22) PCT Filed: Sep. 29, 2015
(86) PCT No.: PCT/JP2015/077560

§ 371 Date: Aug. 16, 2017

(30) Foreign Application Priority Data
Feb. 18, 2015 (JP) 2015-030067

(51) Int. Cl. G06Q 50/26; G06Q 50/08; G06Q 50/30; G08G 1/0969

(52) U.S. Cl. CPC G06Q 50/26; G06Q 50/08; G06K 9/00818; G08G 1/0969; G06Q 50/30

(57) ABSTRACT

According to an embodiment, an information processing device includes an input, a first storage, an acquirer, and a second storage. The input receives image data from an imager that captures, from a vehicle, an image of surroundings of the vehicle. The first storage stores, in correlation with each other, identification information for identifying a road structure contained in the image data for guiding the vehicle, and category information indicating a category of the road structure. The acquirer acquires location information representing a spot at which the vehicle is traveling. The second storage stores, in correlation with one another, the image data from which the road structure is detected based on the identification information stored in the first storage, the category information, and the location information indicating a spot at which the vehicle is traveling at the time of capturing the image data containing the road structure.

### FIELD

An embodiment of the present invention relates generally to an information processing device, a road structure management system, and a road structure management method.

### BACKGROUND

Conventionally, highways and major roads have been inspected for road pavement maintenance with a road surface measuring vehicle, for example. Road structures including signs and traffic mirrors are also inspected for maintenance and management purposes. It is preferable to inspect these road structures and repair them when needed. At present, road structure inspections are hardly automated but visually conducted.

Meanwhile, there is a proposed technique for a vehicle incorporating a camera to identify the actual location of the vehicle from a road sign included in an image captured with the camera. To implement such a technique, it is necessary to know the locations of road structures including road signs beforehand.

### CITATION LIST

### Patent Literature

Patent Literature 1: Japanese Patent Application Laid-open Publication No. 2008-297764

Patent Literature 2: Japanese Patent Application Laid-open Publication No. 2010-92403

### SUMMARY OF THE INVENTION

### Problem to be Solved by the Invention

However, road structures are dispersedly installed in wide areas. Thus, even local governments may not be able to know the locations of road structures standing in their own regions for managing types of the road structures and levels of degradation thereof. It is thus difficult to know the locations of the widely dispersed road structures and inspect them for degradation.

### Means for Solving Problem

An information processing device according to one embodiment includes an input, a first storage, an acquirer, and a second storage. The input receives image data from an imager that captures, from a vehicle being in motion, an image of surroundings of the vehicle. The first storage stores, in correlation with each other, identification information for identifying a road structure contained in the image data for guiding the vehicle while traveling on a road, and category information indicating a category of the road structure. The acquirer acquires location information representing a spot at which the vehicle is traveling. The second storage stores, in correlation with one another, the image data from which the road structure is detected based on the identification information stored in the first storage, the category information correlated with the identification information in the storage, and the location information acquired by the acquirer and indicating a spot at which the vehicle is traveling at the time of capturing the image data containing the road structure.

### BRIEF DESCRIPTION OF DRAWINGS

FIG. 1 illustrates an exemplary configuration of a road structure management system according to one embodiment.

FIG. 2 illustrates an example of the configuration of an information processing device of the embodiment.

FIG. 3 illustrates an exemplary concept of a road structure dictionary of the embodiment.

FIG. 4 illustrates an exemplary database as the road structure dictionary for detecting road signs.

FIG. 5 illustrates a temporal transition of image data captured by a front monitoring camera by way of example.

FIG. 6 illustrates an example of integrating the image data captured by the front monitoring camera with image data captured by a rear monitoring camera.

FIG. 7 illustrates an example of an integration of road structures when they are connected together.

FIG. 8 illustrates an exemplary table structure of a road inspection information storage of the embodiment.

FIG. 9 illustrates exemplary categories of condition of a road structure evaluated by a degradation evaluator of the embodiment.

FIG. 10 illustrates information on a result of the evaluation of each road structure by the degradation evaluator of the embodiment by way of example.

FIG. 11 illustrates a result of the evaluation by the degradation evaluator of the embodiment.

FIG. 12 illustrates an exemplary table structure of a road management information storage of the embodiment.

FIG. 13 illustrates an exemplary display screen on a display 151 by a display controller of the information processing device of the embodiment.

FIG. 14 illustrates an exemplary detailed display screen by the display controller.

FIG. 15 is a flowchart of the overall procedure performed by the information processing device of the embodiment.

FIG. 16 is a flowchart of the overall procedure performed by the information processing device of the embodiment.

### DETAILED DESCRIPTION

Next, an information processing device, a road structure management system, and a road structure management method according to one embodiment will be described, referring to the accompanying drawings.

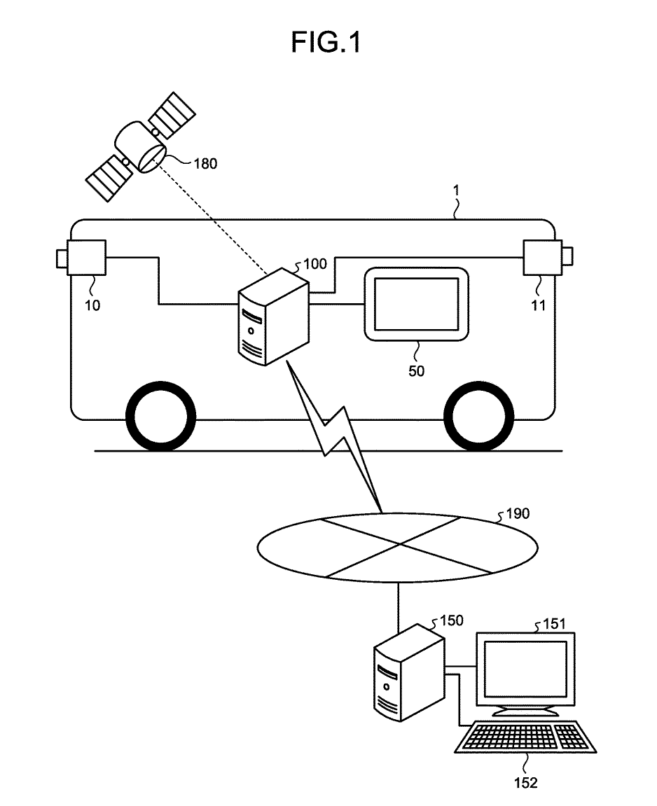

FIG. 1 illustrates an exemplary configuration of the road structure management system of the embodiment. As illustrated in FIG. 1, the road structure management system enables the communication between an information processing device 100 mounted in a vehicle 1 and an information processing device 150 via a public network 190.

The vehicle 1 incorporates a front monitoring camera 10, a rear monitoring camera 11, the information processing device 100, and a display 50. In the vehicle 1 the display 50 can display input image data from the front monitoring camera 10 and the rear monitoring camera 11 via the information processing device 100, for example.

The information processing device 100 can know the actual location of the vehicle 1 and current time from information acquired from a GPS satellite 180.

The front monitoring camera 10 and the rear monitoring camera 11 capture image data and output it to the information processing device 100 while the vehicle 1 is in motion. The information processing device 100 detects a road structure from the image data and specifies a category of the road structure to record the image data including the road structure and the location and the time at which the image data concerned is captured, in connection with each other.

The information processing device 100 then transmits information on the road structure to the information processing device 150 via the public network 190. The present embodiment describes, but should not be limited to, the transmission of information on a road structure. Alternatively, the information may be transferred via a storage medium, or a storage device (such as an HDD) connected to the information processing device 100 may be disconnected and connected to the information processing device 150.

The information processing device 150 is connected to an input device 152 and a display 151 to be able to display the information on the road structure detected by the vehicle 1, for example.

The information processing device 150 receives the road structure information from the information processing device 100 and maps the detected road structure on map data on the basis of the received information, to be able to display the map data together with the information indicating the road structure. The information processing device 150 further evaluates degradation of the road structure, for example.

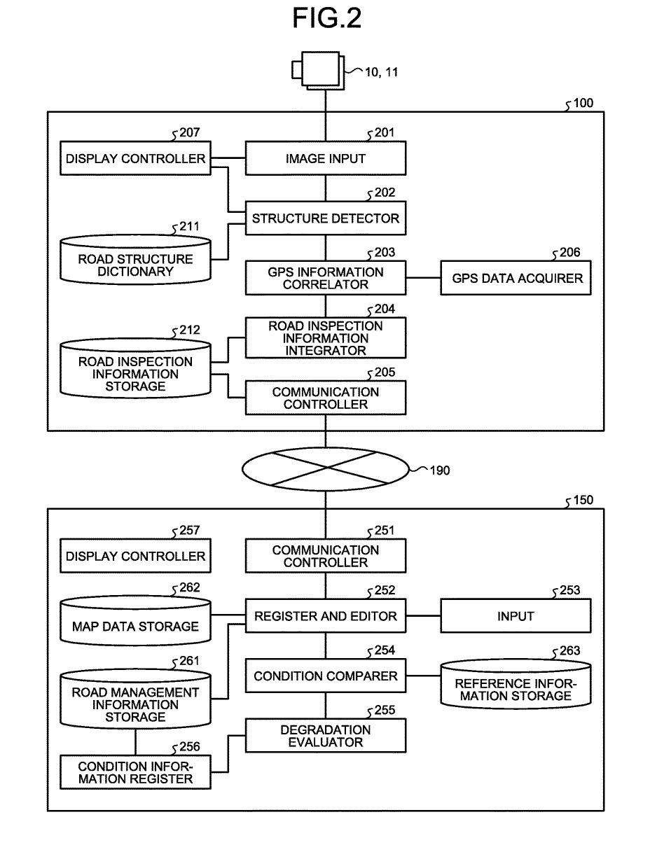

Next, the configurations of the information processing device 100 and the information processing device 150 are described. FIG. 2 illustrates exemplary configurations of the information processing device 100 and the information processing device 150 of the embodiment.

The information processing device 100 is a device mounted on the vehicle 1 and includes a CPU (not illustrated) that executes a control program stored in a storage device (not illustrated) to implement an image input 201, a structure detector 202, a GPS information correlator 203, a road inspection information integrator 204, a communication controller 205, a GPS data acquirer 206, and a display controller 207.

The information processing device 100 further includes a road structure dictionary 211 and a road inspection information storage 212 on a non-volatile storage device.

The road structure dictionary 211 is a dictionary for use in detecting road structures for guiding vehicles from captured image data.

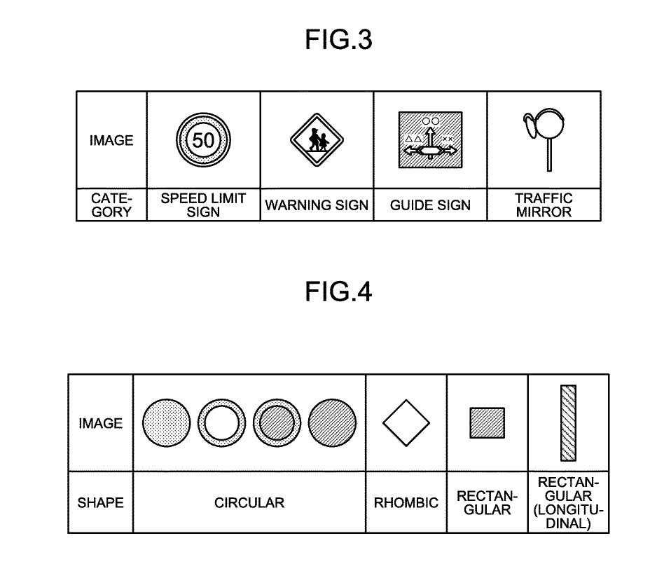

FIG. 3 illustrates an exemplary concept of the road structure dictionary 211 of the embodiment. As illustrated in FIG. 3, it stores identification image data for identifying road structures to detect and category information indicating categories of such road structures, in correlation with each other.

The road structure dictionary 211 further stores images for detecting road signs among the road structures and the shapes of the images, in connection with each other.

FIG. 4 illustrates the road structure dictionary 211 is an exemplary database for detecting road signs in the embodiment. When captured image data contains shapes similar to the ones in FIG. 4, the shapes can be regarded as road signs. Also, the structure dictionary 211 can hold different kinds of shapes for guide signs and traffic mirrors.

The image input 201 receives image data from the front monitoring camera 10 and the rear monitoring camera 11 which capture, from the vehicle 1, an image of the surroundings of the vehicle 1.

The structure detector 202 detects a road structure from the input image data processed by the image input 201, referring to the road structure dictionary 211.

The structure detector 202 according to the embodiment extracts an area of the image data as a candidate of a road structure, on the basis of the colors or shapes of the road structures as illustrated in FIG. 4. The structure detector 202 then compares the extracted area with the identification image data as shown in FIG. 3 to determine the category of the road structure from a relationship between the identification image data and the category information.

There are two types of road signs, that is, fixed signs providing fixed information and variable (electronic) signs providing dynamically changing information. The structure detector 202 of the embodiment can detect both of the two types. Electronic signs include character areas which are sets of high-luminance points made of lamps as LEDs, periodically blinking on and off. The structure detector 202 of the embodiment can thus detect electronic signs by comparing time-series images in addition to the pattern recognition.

The structure detector 202 may estimate the orientation of the road structure appearing in the image data on the basis of the aspect ratio (vertical to horizontal ratio) of a size of the road structure. When determining that the road structure is obliquely captured, the structure detector 202 can convert and correct the image data to squarely captured image data, using time-series image data items.

The GPS data acquirer 206 acquires, from the GPS satellite 180, location information representing a spot at which the vehicle 1 is traveling and time at which the vehicle 1 is traveling at the spot.

The GPS information correlator 203 correlates the image data from which the structure detector 202 has detected the road structure with the location information and the time acquired by the GPS data acquirer 206.

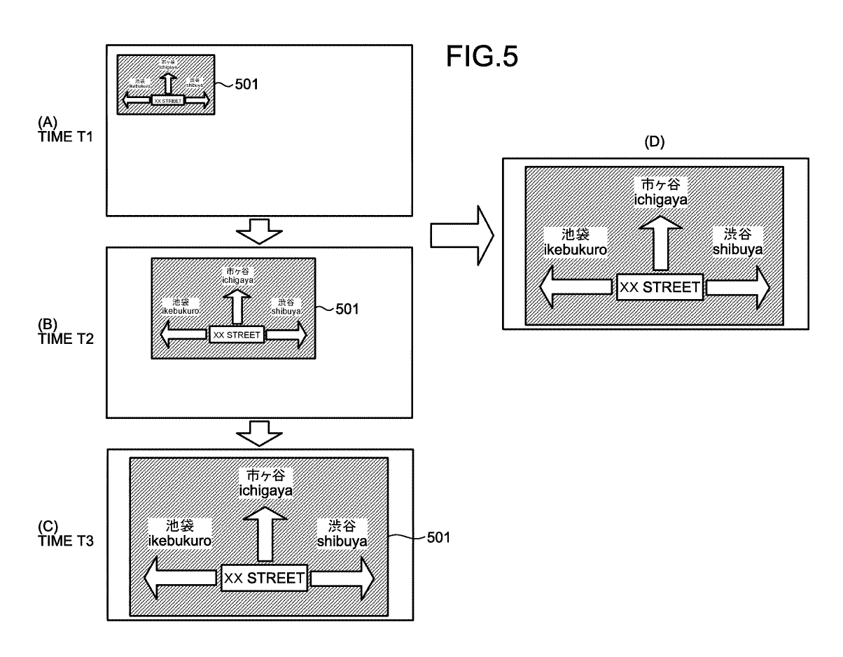

The road inspection information integrator 204 integrates multiple image data items. FIG. 5 illustrates a temporal transition of image data captured by the front monitoring camera 10 by way of example. As illustrated in FIG. 5, the front monitoring camera 10 may shoot a same road structure 501 two or more times at time T1, T2, and T3, for instance, while the vehicle 1 is running. In such a case, holding multiple image data items will increase data volume. In view of this, upon determining, through the comparison of image data items, that the same road structure 501 has been shot multiple times, the road inspection information integrator 204 selects any of the image data items as a representative to integrate the information on the same road structure 501.

FIG. 5 shows captured image data items (A) to (C) as an example. The road inspection information integrator 204 is assumed to select the image data item (C) from the image data items (A) to (C) as representative image data (D). The image data can be selected in an arbitrary manner, however, image data including a distinctively identifiable road structure is to be preferably selected.

The image data integration is carried out not only when the same road structure is shot multiple times during a single travel as shown in FIG. 5, but also when the same road structure is shot multiple times during two or more travels on the same road on the same day or in a few days.

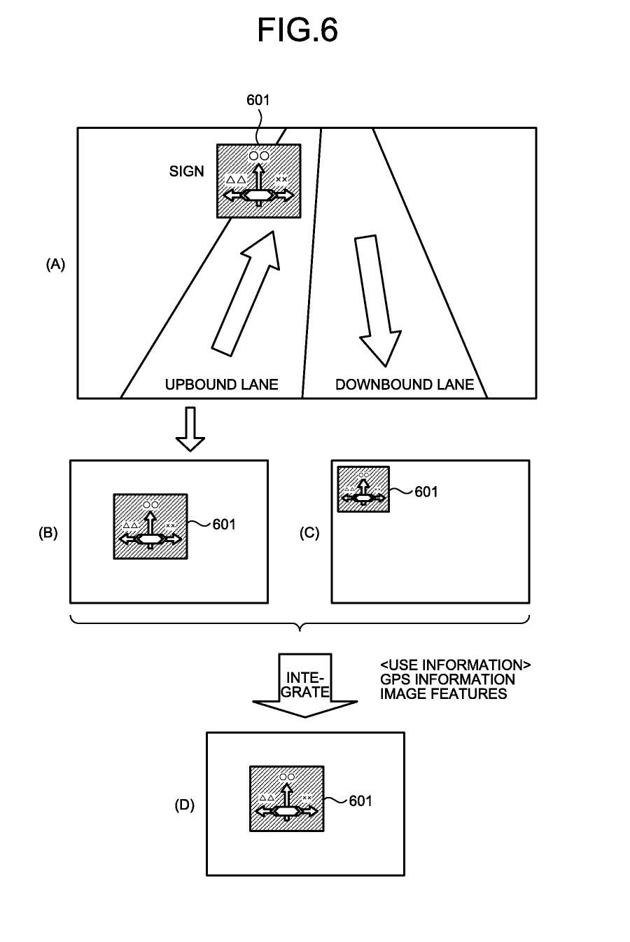

FIG. 6 shows an example of integrating image data captured by the front monitoring camera 10 and the image data captured by the rear monitoring camera 11. In FIG. 6 image data (A) is captured by the front monitoring camera 10 while the vehicle 1 is moving on an upbound lane. The image data (B) shows a road structure 601 detected from the image data (A). The road structure 601 is also shown in the image data captured by the rear monitoring camera 11 while the vehicle 1 is moving on a downbound lane. The image data (C) shows the road structure 601 detected from the image data captured by the rear monitoring camera 11 while the vehicle 1 is moving on the downbound lane.

The road inspection information integrator 204 selects, as a representative, one of the multiple image data items, i.e., the image data captured during the vehicle moving on the upbound lane and the image data captured during the vehicle moving on the downbound lane, when they show the same road structure 601, to integrate the information on the road structure 601, as shown in the image data (D).

The road inspection information integrator 204 executes when the location information, acquired from the GPS satellite 180, indicating the spots where the image data items are captured is included in a certain area and upon determining that the road structures contained in the image data items are the same as a result of comparing feature information on the road structures.

Meanwhile, upon detecting two or more road structures from a single image data item, the structure detector 202 identifies them as different road structures and generates different image data items thereof. However, the road inspection information integrator 204 groups the two or more road structures into one as a same road structure if they are connected to one another.

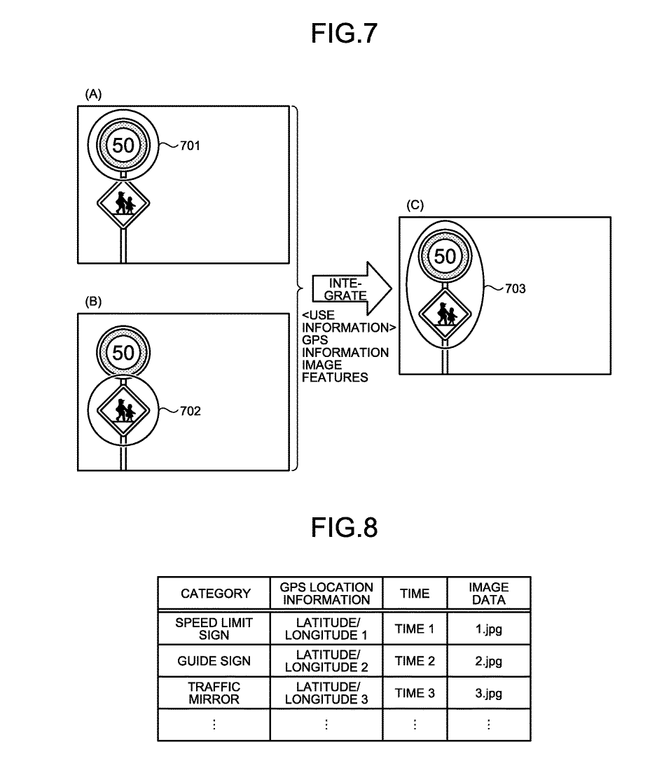

FIG. 7 shows an example of the integration of connected road structures. The image data (A) in FIG. 7 shows a detected road structure 701 while the image data (B) in FIG. 7 shows a detected road structure 702. In such a case, when determining that connected road structures are placed from the location information and the feature information on the road structures contained in the image data, the road inspection information integrator 204 groups the road structures concerned to process them as a road structure group 703, as shown in the image data (C) of FIG. 7.

The road inspection information integrator 204 registers information on the integrated road structure in the road inspection information storage 212.

FIG. 8 illustrates an exemplary table structure of the road inspection information storage 212. As illustrated in FIG. 8, the road inspection information storage 212 stores category, GPS location information, time, and image data in correlation with one another. The image data is the representative image data selected by the road inspection information integrator 204 from the image data items from which the road structures are detected referring to the road structure dictionary 211. The category shows types of road structures contained in the image data and specified on the basis of the category information correlated with the identification image data in the road structure dictionary 211. The GPS location information refers to the location information indicating the spot where the vehicle 1 is traveling, and acquired by the GPS data acquirer 206 at the time when the image data containing the road structure concerned is being captured. The time refers to time at which the image data concerned is being captured.

Meanwhile, the electronic signs convey different contents of information depending on time of day, weather, season, and traffic conditions and the information may change every time the vehicle passes. Many fixed signs include a single pole and two or more signs attached to the pole. In view of this, the road inspection information storage 212 has a data structure in which different types of category information can be added and managed for a single road structure as attribute information. In FIG. 8 a number of types of category information can be stored in the category column by way of example.

Referring back to FIG. 2, the communication controller 205 transmits and receives information to and from the information processing device 150. The communication controller 205 transmits, for example, the information stored in the road inspection information storage 212 to the information processing device 150.

The display controller 207 controls the display of the image data captured with the front monitoring camera 10 or the rear monitoring camera 11 and the information stored in the road inspection information storage 212 on the display 50.

The information processing device 150 is provided in a center which manages road structures, and includes a CPU (not illustrated) that executes a control program stored in a not-illustrated storage device to implement a communication controller 251, a register and editor 252, an input 253, a condition comparer 254, a degradation evaluator 255, a condition information register 256, and a display controller 257.

The information processing device 150 further includes a map data storage 262, a road management information storage 261, and a reference information storage 263 on a non-volatile storage device.

The communication controller 251 transmits and receives information to and from the information processing device 100. For instance, the communication controller 251 receives the information stored in the road inspection information storage 212 from the information processing device 100.

The register and editor 252 aggregates the information received by the communication controller 251 and registers it in the road management information storage 261.

The input 253 processes an operation input with the input device 152. The register and editor 252 edits the information in accordance with the operation processed by the input 253. For example, the register and editor 252 may extract important information alone from the information received by the communication controller 251 in accordance with the operation to register the extracted information in the road management information storage 261.

For the registration in the road management information storage 261, data can be classified by, for example, year, region, or route for individual purposes.

The register and editor 252 maps the location of a road architecture on map data stored in the map data storage 262, on the basis of the GPS location information in the received information.

The map data storage 262 stores the map data. The map data storage 262 stores information on the road architecture standing in the location, mapped by the register and editor 252, on the map data.

The condition comparer 254 compares conditions of the road structure registered in the road management information storage 261. The condition comparer 254 of the embodiment compares image data items of the road structure, which have been captured at different times and dates from past to present, registered in the road management information storage 261. Further, the condition comparer 254 compares the image data of the road structure stored in the road management information storage 261 with comparison-reference image data of the road structure with no degradation, the comparison-reference image data which is prepared and registered by category in the reference information storage 263. Before the comparison, the condition comparer 254 may also correct the color and brightness of captured image data, taking time or a weather condition at the time of capturing the image data into account.

The reference information storage 263 stores the image data containing road structures with no degradation. The level of degradation can be determined by comparison between the image data concerned and the image data stored in the reference information storage 263.

The present embodiment has described the exemplary use of both the reference information storage 263 and the road management information storage 261 for the storage containing the reference image data for detecting degradation of a road structure in image data. However, only either one of them can be used.

The degradation evaluator 255 evaluates the degradation of the road structure registered in the road management information storage 261, on the basis of a result of the comparison by the condition comparer 254. The degradation evaluator 255, for example, compares the colors of the comparison-reference image data and the most current image data of the road structure to detect a change in the condition of the road structure from a result of the comparison. It further detects a change in the condition of the road structure from a result of the comparison between the colors of different image data items in time series.

According to the present embodiment, the items of evaluation are defined for each category of the road structures and an evaluation method is defined for each item of the evaluation. Scores indicating the levels of degradation are calculated by the evaluation methods to evaluate the conditions of the road structures based on the scores.

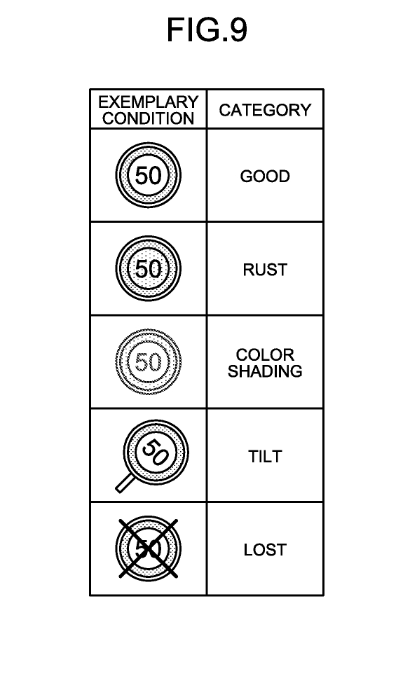

FIG. 9 illustrates the categories of the condition of a road structure evaluated by the degradation evaluator 255 of the embodiment by way of example. As illustrated in FIG. 9, the degradation evaluator 255 determines the condition of the road structure from four items of evaluation, rust, color fading, tilt, and lost. FIG. 9 exemplifies the four items of evaluation, rust, color fading, tilt, and lost, however, the evaluation items should not be limited thereto.

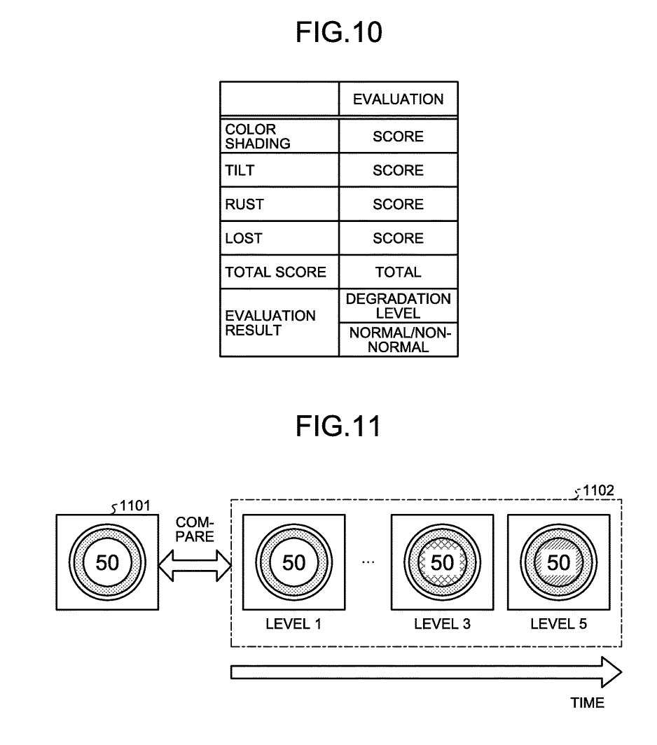

FIG. 10 illustrates an example of information on results of the evaluation of each road structure by the degradation evaluator 255 of the embodiment. As illustrated in FIG. 10, the degradation evaluator 255 calculates a score of the condition (degree of degradation) of a road structure in each evaluation item on the basis of the image data of a road traffic-related object stored in the road management information storage 261. In the present embodiment the degradation evaluator 255 compares the most current image data of a road traffic-related object in question among the image data stored in the road management information storage 261 with the image data of the same road traffic-related object stored in the reference information storage 263, to be able to derive the score for each evaluation item by plugging results of the comparison into a formula defined for each evaluation item.

The present embodiment should not be limited to the comparison with the image data of the same road traffic-related object stored in the reference information storage 263. Alternatively, different time-series image data items (such as old image data and new image data) of the same road traffic-related object are compared to plug the resultant into the formula defined for each evaluation item and derive the score for each evaluation item.

The degradation evaluator 255 of the embodiment calculates a total score of the evaluation items, compares the total score with a threshold, and, when the total score matches or exceeds the threshold, evaluates the condition (level of degradation) of the road structure in multiple levels (five levels, for example) on the basis of the magnitude of the total score. In the present embodiment, when the total score results in smaller than the threshold, the road structure is determined as normal while when the total score results in the threshold or above, it is determined as non-normal.

FIG. 11 illustrates an exemplary result of the evaluation by the degradation evaluator 255 of the embodiment. The example in FIG. 11 is that the road traffic-related object is evaluated on the basis of image data 1101 stored in the reference information storage 263. The example in FIG. 11 shows a result of the evaluation of an image data group 1102 of the same road structure captured multiple times over time. It can be seen from FIG. 11 that in the degradation evaluation of the same road structure, the level of degradation rises over time.

The degradation evaluator 255 also determines a speed of degradation of the road structure from a current degradation level and a previous degradation level thereof. Specifically, when the current degradation level approximately matches the previous degradation level, it determines the degradation speed as slow. When the current degradation level sharply changes from the previous degradation level, it determines the degradation speed as fast.

The degradation evaluator 255 transfers the evaluation result to the condition information register 256. The condition information register 256 registers the evaluation result in the road management information storage 261.

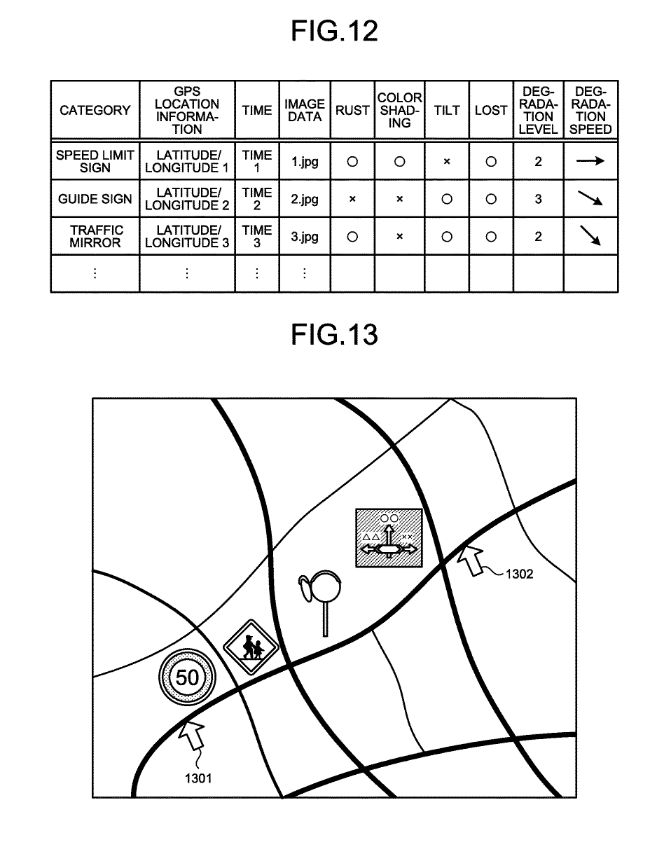

FIG. 12 illustrates an exemplary table structure of the road management information storage 261. As illustrated in FIG. 12, in the road management information storage 261 category, location information, time, and image data, the evaluation items, rust, color shading, tilt, and lost, and degradation level and degradation speed are correlated with one another. Among them, the category, GPS location information, time, and image data are the information transferred from the information processing device 100. The evaluation items, rust, color shading, tilt, and lost, and the level and speed of degradation are the results of the evaluation by the degradation evaluator 255. In the example of FIG. 12 either of the symbols “o” and “x” is set depending on whether the score for each of the evaluation items matches or exceeds a certain score.

The display controller 257 of the information processing device 150 displays various kinds of information on the display 151 in accordance with an operation with the input device 152. For example, the display controller 257 displays the image data of the road structure stored in the road management information storage 261, the road structure having a degradation detected through the comparison with the image data stored in the reference information storage 263 or the road management information storage 261.

The display controller 257 also displays the map data stored in the map data storage 262 together with the image data of the road structure correlated with the GPS location information corresponding to the location on the map data.

FIG. 13 illustrates an exemplary display screen on the display 151 by the display controller 257 of the information processing device 150. In the example of FIG. 13 the display controller 257 displays the map data stored in the map data storage 262 and the image data of road structures mapped on the map data (image data correlated with the GPS location information corresponding to the location on the map data). Upon receipt of an area selection on the screen data shown in FIG. 13 by the input 253, the display controller 257 can display the road structures included in the selected area in detail.

The map data shown in FIG. 13 is changeable in scale size, position, and displayed information in accordance with an operation received by the input 253.

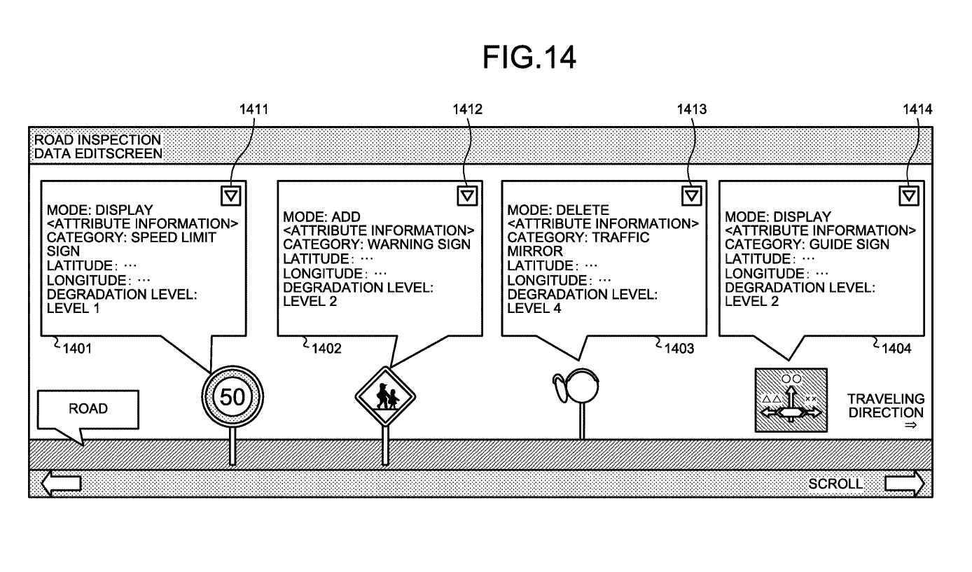

FIG. 14 illustrates an example of a detailed display screen by the display controller 257 when points 1301 and 1302 in FIG. 13 are selected. The exemplary detailed display screen of FIG. 14 shows various items of attribute information in windows 1401 to 1404 set for the respective road structures included in the selected area. The displayed attribute information includes category, latitude, longitude, and degradation level (degradation condition) by way of example, and it can include the results of the evaluation. For instance, the display controller 257 can display the score for each evaluation item of each road structure or the degradation speed thereof as an evaluation result.

The image data of the road structures displayed on the detailed display screen by the display controller 257 is defined to be the most current image data thereof. That is, the display controller 257 displays, on the detailed display screen, the image data containing the road structure having a degradation detected. This can allow an administrator to visually check the degradation level.

The various items of attribute information on the detailed display screen may be editable. With a large area selected, the displayed road structures can be changed by receiving press-down of a scroll button provided at the bottom end of the screen.

If the information processing device 100 erroneously detects a road structure from the image data, information on the road structure in question can be deleted by selecting a delete mode from modes 1411 to 1414 displayed for the respective road structures. Additional information on the road structures can be added when needed. When visually checking the image data captured by the front monitoring camera 10 and the rear monitoring camera 11 and finding a non-detected structure, the administrator can add the category and the location information (latitude and longitude information) about the road structure on the detailed display screen, for example.

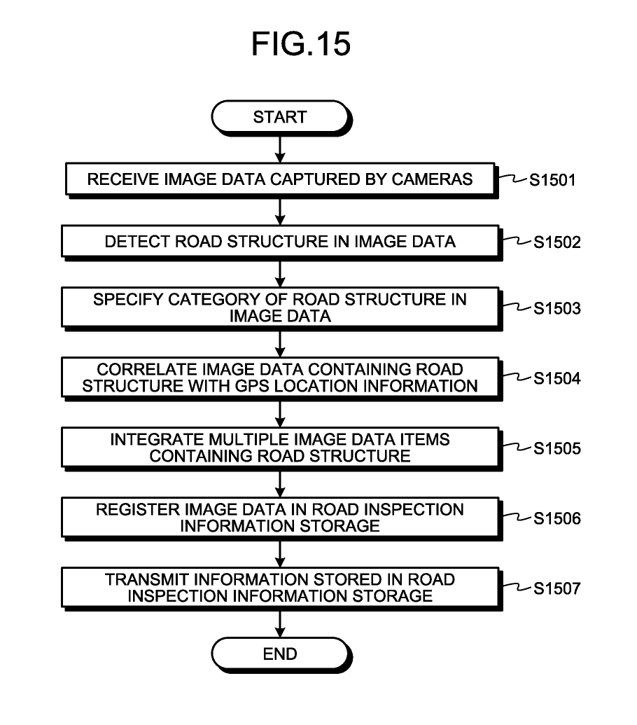

Next, the overall procedure performed by the information processing device 100 mounted on the vehicle 1 is described. FIG. 15 is a flowchart of the above procedure by the information processing device 100 according to the embodiment.

First, the image input 201 receives image data captured by the front monitoring camera 10 and the rear monitoring camera 11 (S1501).

The structure detector 202 then detects a road structure from the image data, referring to the road structure dictionary 211 (S1502).

The structure detector 202 specifies the category of the road structure in the image data (S1503) and correlates the specified category with the image data.

The GPS information correlator 203 correlates the image data containing the road structure with the GPS location information acquired by the GPS data acquirer 206 (S1504).

The road inspection information integrator 204 integrates multiple image data items containing the road structure and selects representative image data therefrom (S1505).

The road inspection information integrator 204 correlates the representative image data, the GPS location information, category, and time with one another and registers them in the road inspection information storage 212 (S1506).

The communication controller 205 transmits the information stored in the road inspection information storage 212 to the information processing device 150 (S1507).

Through the above procedure, the information on the detected road structure is transferred to the information processing device 150.

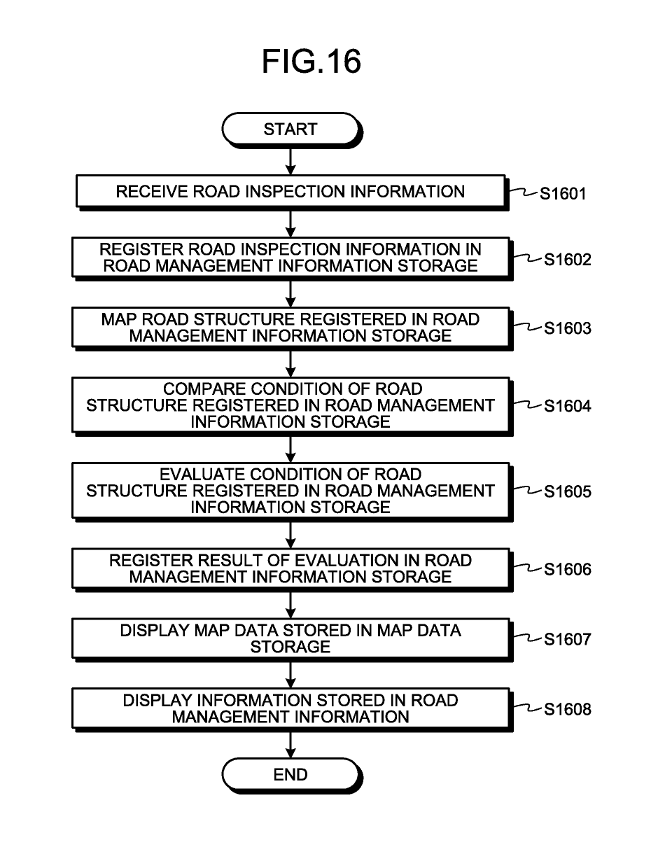

Next, the overall procedure performed by the information processing device 150 according to the embodiment is described. FIG. 16 is a flowchart of the above procedure by the information processing device 150 of the embodiment.

First, the communication controller 251 receives road inspection information indicating information on a road structure to inspect, from the information processing device 100 (S1601).

The register and editor 252 then registers the received road inspection information (image data, category, GPS location data, time) in the road management information storage 261 (S1602).

Next, the register and editor 252 maps, on the map data stored in the map data storage 262, the registered road structure in the road management information storage 261 (S1603).

The condition comparer 254 compares the condition of the road structure registered in the road management information storage 261 on the basis of the image data of the road structure (S1604). For example, the condition comparer 254 compares the most current image data and old image data among the image data of the road structure in the same location. The condition comparer 254 also compares the most current image data with image data containing a road structure of the same category as that of the road structure in the most current image data among the image data stored in the reference information storage 263.

The degradation evaluator 255 evaluates the condition of the road structure registered in the road management information storage 261 on the basis of a result of the comparison in S1604 (S1605).

The condition information register 256 registers a result of the evaluation as the condition of the road structure registered in the road management information storage 261 (S1606).

The display controller 257 displays the map data stored in the map data storage 262 in accordance with an operation received by the input 253 (S1607).

The display controller 257 then displays the information stored in the road management information storage 261 in accordance with an operation received by the input 253 (S1608). The displayed information includes the level of degradation and the most current one of the image data containing the road structure, for example.

Through the above procedure, the administrator can identify the levels of degradation of the road structures set in the traveling area of the vehicle 1.

According to the embodiment described above, without pre-registered information on the locations and categories of the road structures, the road structures are detected from the captured image data, and the categories thereof are specified and stored in correlation with the GPS location information. By comparison between the captured image data and previous image data or image data containing road structures with no degradation, the levels of degradation of the road structures can be identified. This makes it possible for the administrator to identify, without the pre-registration, the levels of degradation of the road structures installed in the managed areas.

The above embodiment enables the detection of road structures installed in the managed areas and the evaluation of degradation thereof even with no pre-registered information on the locations and categories of the road structures, which can facilitate the management of the road structures.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An information processing device comprising:
an input that receives image data from an imager, the imager that captures, from a vehicle being in motion, an image of surroundings of the vehicle;
a first storage that stores identification information and category information in correlation with each other, the identification information being for identifying a road structure contained in the image data, the road structure being for guiding the vehicle while traveling on a road, the category information indicating a category of the road structure;
an acquirer that acquires location information representing a spot at which the vehicle is traveling; and
a second storage that stores the image data, the category information, and the location information in correlation with one another, the image data from which the road structure is detected based on the identification information stored in the first storage, the category information correlated with the identification information in the first storage, the location information acquired by the acquirer and indicating a spot at which the vehicle is traveling at the time of capturing the image data containing the road structure.

2. The information processing device according to claim 1, wherein
the input receives multiple image data items; and
the first storage stores one of the received image data items when the image data items contain a same road structure.

3. A road structure management system that manages a road structure installed along a road, comprising:
an input that receives image data from an imager, the imager that captures, from a vehicle, an image of surroundings of the vehicle;
a first storage that stores identification information and category information in correlation with each other, the identification information being for identifying a road structure contained in the image data, the road structure being for guiding the vehicle while traveling on a road, the category information indicating a category of the road structure;
an acquirer that acquires location information representing a spot at which the vehicle is traveling; and
a second storage that stores an image data item of the image data imaged by the imager, the category information, and the location information in correlation with one another, the image data item containing the road structure detected based on the identification information stored in the first storage, the category information correlated in the first storage with the identification information indicating the contained road structure, the location information acquired by the acquirer and representing a spot at which the vehicle is traveling at the time of capturing the image data containing the road structure.
a third storage that stores reference image data, the reference image data being for detecting a degradation of the road structure contained in the image data; and
a display that displays the image data stored in the second storage, the image data containing the road structure having a degradation detected based on the reference image data stored in the third storage.

4. The road structure management system according to claim 3, further comprising a map storage that stores map information, wherein the display further displays the map information stored in the map storage and the image data correlated with the location information corresponding to a location on the map information.

5. The road structure management system according to claim 3, wherein the reference image data stored in the third storage contains the road structure having no degradation.

6. The road structure management system according to claim 3, wherein the reference image data stored in the third storage contains a same road structure as that in the image data received by the input, and is image data captured more previously than the image data received by the input.

7. The road structure management system according to claim 3, wherein the display further displays a level of the degradation of the road structure together with the image data containing the road structure having a degradation detected.

8. The road structure management system according to claim 3, wherein
the input receives multiple image data items; and
the first storage stores one of the received image data items when the image data items contain a same road structure.

9. A road structure management method to be executed by an information processing device, the information processing device comprising a first storage that stores identification information and category information in correlation with each other, the identification information being for identifying a road structure contained in the image data, the road structure being for guiding the vehicle while traveling on a road, the category information indicating a category of the road structure, the method comprising:
receiving image data from an imager by an input, the imager that captures, from a vehicle being in motion, an image of surroundings of the vehicle;
acquiring, by an acquirer, location information representing a spot at which the vehicle is traveling; and
storing the image data, the category information, and the location information in a second storage in correlation with one another, the image data from which the road structure is detected based on the identification information stored in the first storage, the category information correlated with the identification information in the first storage, the location information acquired by the acquirer and indicating a spot at which the vehicle is traveling at the time of capturing the image data containing the road structure.
